(19) United States
(12) Patent Application Publication
(10) Pub. No.: US 2024/0375144 A1
(43) Pub. Date: Nov. 14, 2024

(54) A COATING SYSTEM FOR COATING A SUBSTRATE AND A METHOD OF COATING THE SUBSTRATE WITH THE SAME

(71) Applicant: BASF CORPORATION, Florham Park, NJ (US)

(72) Inventors: Yuting LI, Shanghai (CN); Yunfei QI, Shanghai (CN); Juncong JIANG, Beijing (CN); Chenghao DENG, Shanghai (CN); Attilio SIANI, Hannover (DE); Jiancheng LIU, Shanghai (CN); Xiaomin YIN, Shanghai (CN)

(21) Appl. No.: 18/684,554

(22) PCT Filed: Aug. 18, 2022
(86) PCT No.: PCT/CN2022/113351

§ 371 Date: Feb. 16, 2024

(30) Foreign Application Priority Data
Aug. 18, 2021 (WO) PCT/CN2021/113507

(51) Int. Cl. B05C 11/10; B05C 13/02

(52) U.S. Cl. CPC B05C 11/101; B05C 13/02

(57) ABSTRACT

A coating system for coating a substrate, comprises: a dosing unit for pre-weighing a solid material to be conveyed; a conveying unit for conveying the weighed solid material to the substrate to be coated by a conveying gas flow; a receiving unit for receiving the substrate and located downstream of the conveying unit along a flowing direction of the conveying gas flow; an automatic transfer mechanism for transferring the substrate to the receiving unit and removing the coated substrate out of the receiving unit; a control unit for controlling the operation of the dosing unit, the receiving unit and the automatic transfer mechanism; and a gas flow generating device for generating the conveying gas flow. A method of coating a substrate; with said coating system is also related.

### TECHNOLOGY FIELD

The invention relates to a coating system for coating a substrate, in particular a substrate for a wall-flow filter and a process of coating the substrate with the coating system.

### BACKGROUND

Certain internal combustion engines, for example lean-burn engines, diesel engines, natural gas engines, power plants, incinerators, and gasoline engines, tend to produce an exhaust gas with a considerable amount of soot and other particulate matter. Usually, particulate matter emissions can be remedied by passing the PM-containing exhaust gas through a wall-flow filter.

Diesel wall-flow filter have proven to be efficient at removing carbon soot from the exhaust gas of the diesel engines. The most widely used diesel particulate filter is the wall-flow filter which filters the diesel exhaust gas by capturing the soot on the porous walls of the filter body. The wall-flow filter is designed to provide for nearly complete filtration of soot without significantly hindering the exhaust flow.

There is a need to provide an improved coating system and coating process to obtain a filter, e.g., a wall-flow filter having excellent filtration efficiency and low backpressure.

Lately, even stricter regulations like Euro 6d and China 6b were imposed, and the conventional catalytic filter technology was not able to simultaneously meet the customer's emission targets for particulate matter & backpressure targets for exhaust system without further improvement. This created an urgent need for developing the next generation catalytic filter (or FWC) and at the same time a new coating system to be able to produce this next generation product in large scale.

### SUMMARY OF THE INVENTION

It is an object of the present invention to provide an improved coating system for more efficiently preparing a filter having excellent filtration efficiency and low backpressure.

Another object of the present invention to provide an improved coating process for more efficiently preparing a filter having excellent filtration efficiency and low backpressure.

So, one aspect of the present invention relates to a coating system for coating a substrate, comprising: a dosing unit for pre-weighing a solid material to be conveyed; a conveying unit for conveying the weighed solid material to the substrate to be coated by a conveying gas flow; a receiving unit for receiving the substrate and located downstream of the conveying unit along a flowing direction of the conveying gas flow; an automatic transfer mechanism for transferring the substrate to the receiving unit and removing the coated substrate out of the receiving unit; a control unit for controlling the operation of the dosing unit, the receiving unit and the automatic transfer mechanism; and a gas flow generating device for generating the conveying gas flow.

In an embodiment, the dosing unit may comprise an automatic material dosing device having a material container with a dispensing port and a dispensing mechanism arranged in the material container; a material transfer container; and a weighing device; wherein the dispensing mechanism is used for dispensing the solid material into the material transfer container through the dispensing port, and the weighing device is used for weighing the solid material in the material transfer container.

In an embodiment, the dispensing mechanism and the weighing device may be respectively in communication with the control unit, and the control unit receives a weight measurement value of the solid material dispensing into the material transfer container from the weighing device, and compares the weight measurement value with the set weight of the solid material to be conveyed, and the control unit will control the dispensing mechanism to stop dispensing the solid material, if the weight measurement value is in the range of the set weight±5%.

In an embodiment, the conveying unit may comprise a conveying pipe comprising a first cylindrical pipe section, a second cylindrical pipe section, a second conical pipe section and a third cylindrical pipe section which are sequentially connected; wherein the second cylindrical pipe section is movably connected to the first cylindrical pipe section such that the second cylindrical pipe section can move between a first position in which the third cylindrical pipe section may drop down to be airtightly connected with the receiving unit and cover the substrate, and a second position in which the third cylindrical pipe section may lift up to leave an enough space for the automatic transfer mechanism to operate the substrate to be coated or the coated substrate relative to the first cylindrical pipe section.

Preferably, the conveying pipe may be vertically arranged, and may further comprise a first conical pipe section connected to the first cylindrical pipe section, which is used for receiving the weighed solid material; wherein the first conical pipe section is convergent along the flow direction of the conveying gas flow, and the second conical pipe section is divergent along the flow direction of the conveying gas flow.

In an embodiment, the second cylindrical pipe section may have a length which is smaller than that of the first cylindrical pipe section; the second cylindrical pipe section may have a diameter (inner diameter) which is smaller than that of the first cylindrical pipe section; and the third cylindrical pipe section may have a diameter and a height which are selected such that the third cylindrical pipe can cover the substrate to be coated.

Preferably, the inner diameter of the first cylindrical pipe section is defined as D. The second cylindrical pipe section have a diameter which is smaller than that of the first cylindrical pipe section, for example is 2 mm to 5 mm, such as 3 mm smaller than that of the first cylindrical pipe section. The second conical pipe section may have a height which is in the range of 0.5D to 1.5D. The third cylindrical pipe section may have a height which is 1.2 to 1.8D, for example 1.5D. The diameter of the third cylindrical pipe section is selected to be in the range of 2.5D to 3D. In an embodiment, the diameter of the third cylindrical pipe section is larger than that of the diameter of the circular cross-section of the substrate or the minor axis of the elliptical cross-section of the substrate in case the substrate is an elliptic cylinder.

Preferably, the first cylindrical pipe section may have a diameter in the range of 40 mm to 140 mm. The second cylindrical pipe section have a diameter which is 2 mm to 5 mm smaller than that of the first cylindrical pipe section. The second conical pipe section may have a height in the range of 20 mm to 200 mm. The third cylindrical pipe section may have a height in the range of 60 mm to 200 mm. The diameter of the third cylindrical pipe section is selected to be in the range of 100 mm to 400 mm.

In an embodiment, the receiving unit may comprise a holding mechanism for fixedly holding the substrate, and a connecting pipeline for airtightly connecting the holding mechanism and the substrate to the gas flow generating device, wherein a pressure sensor and a flow rate sensor are arranged in the connecting pipeline.

Preferably, the gas flow generating device may be a fan arranged downstream of the receiving unit to generate the conveying gas flow flowing from an inlet end of the conveying pipe to an outlet end thereof; and a cooler is also arranged in the connecting pipeline near the fan.

Preferably, the holding mechanism is an inflatable flexible holder which can be adjusted to hold the substrates of different sizes; and the control unit is in communication with the pressure sensor and the flow rate sensor to receive a gas flow rate and a pressure measured in the connecting pipeline through the pressure sensor and the flow rate sensor; wherein the connecting pipeline has a cross section which is larger than that of the substrate.

In an embodiment, the substrate may be a filter substrate, in particular a wall-flow filter substrate having an inlet side and an outlet side, and the substrate is arranged in the inflatable flexible holder with its inlet side facing the conveying unit. Wherein in the first position, the third cylindrical pipe section may drop down to be airtightly connected to the holding mechanism.

In an embodiment, the coating system further comprises: a loading table on which at least two combinations consisting of the conveying unit and the receiving unit are arranged; a feeding device arranged on one side of the automatic transfer mechanism close to the loading table; and an output device arranged on the other side of the automatic transfer mechanism close to the loading table.

Preferably, the loading table is a circular arc table, and the at least two combinations are installed on the loading table along the circumferential direction of the circular arc; wherein the automatic transfer mechanism is arranged at the center of the circular arc so that the distance from the automatic transfer mechanism to each receiving unit is the same.

More preferably, the loading table is a semi-circular table, and four combinations consisting of the conveying unit and the receiving unit are arranged on the loading table, wherein the automatic transfer mechanism is a robot which is in communication with the control unit, and the control unit controls the robot to determine which receiving unit is in an idle state, and then transfer the substrate to be coated to the receiving unit which is idle.

In an embodiment, the output device may comprise at least two output conveyors, one of the output conveyors may be used for qualified products and the other one of the output conveyors may be used for unqualified products.

Preferably, the coating system may further comprise a backpressure measuring device which may be used for measuring the backpressure of the substrate to be coated, such that the weight of the solid material to be coated on the substrate can be determined based on the measured backpressure value.

Another aspect of the present invention relates to a method of coating a substrate with the above coating system, comprising the steps of: providing the substrate; transferring the substrate to a receiving unit by an automatic transfer mechanism, and fixedly holding the substrate in the receiving unit; pre-weighing a solid material to be coated on the substrate by a dosing unit; mixing the weighed solid material with the conveying gas flow and convey them to the receiving unit by the conveying unit to coat the substrate; and removing the coated substrate from the receiving unit by the automatic transfer mechanism.

Advantageously, in the step of pre-weighing a solid material to be coated on the substrate by a dosing unit, the total weight of the material transfer container and the solid material to be conveyed therein measured by the weighing device is defined as Wt, after feeding the solid materials in the material transfer container into the conveying unit, the material transfer container is re-weighed by the weighing device and the measured value is Wr, then Wt−Wr is the actual material weight G feeding into the conveying unit; if the actual material weight G is in the range of the set weight W±5%, the dosing unit will continue to weigh the solid material for the next substrate, otherwise, the weighing device 16 will send a signal to the control unit to mark the substrate coated in this time as a “reject product”.

Preferably, after the step of removing the coated substrate from the receiving unit, it is possible to judge whether the obtained product is qualified by a backpressure test. For example, if the backpressure of the desired product is P and the measured backpressure Pt=P (1±5%), the product can be judged as a qualified product, otherwise it can be judged as a unqualified product (reject product).

Preferably, the method may further comprise the step of measuring the backpressure of the substrate to be coated by a backpressure measuring device before the pre-weighing step, and determining the weight of the solid material to be coated on the substrate based on the backpressure measurement value.

The coating system according to the present invention is able to simultaneously meet the customer's emission targets for particulate matter & backpressure targets for exhaust system without further improvement. The product (catalytic filter) obtained by this new coating system has a higher trapping efficiency for particulate matter, and at the same time the coating system is able to produce this product in large scale.

### DESCRIPTION OF THE DRAWING

FIG. 1 shows a schematic block diagram of one embodiment of a coating system according to the present invention;

FIG. 2 shows a schematic structural diagram of the dosing unit according to the present invention;

FIG. 3 is a schematic structural diagram shows the conveying unit and the receiving unit;

FIG. 4 is a schematic structural diagram shows the loading table, the feeding device, and the output device; and

FIG. 5 is a schematic structural diagram shows an embodiment of the substrate for wall-flow filter according to the present invention.

### DETAILED DESCRIPTION OF THE EMBODIMENTS

The undefined article “a”, “an”, “the” means one or more of the species designated by the term following said article.

In the context of the present disclosure, any specific values mentioned for a feature (comprising the specific values mentioned in a range as the end point) can be recombined to form a new range.

In the context of the present disclosure, each aspect so defined may be combined with any other aspect or aspects unless clearly indicated to the contrary. In particular, any feature indicated as being preferred or advantageous may be combined with any other feature or features indicated as being preferred or advantageous.

FIG. 1 shows a schematic block diagram of one embodiment of a coating system for coating a substrate 10 according to the present invention. The coating system mainly comprises a dosing unit 1, a conveying unit 2, a receiving unit 3, an automatic transfer mechanism 4, and a control unit 5 for controlling the operation of the dosing unit 1, the receiving unit 3 and the automatic transfer mechanism 4. The dosing unit 1 is used for pre-weighing and dosing a solid material to be conveyed, the conveying unit 2 is used for conveying the weighed solid material to the substrate 10 to be coated by a conveying gas flow, and the automatic transfer mechanism 4 is provided for transferring the substrate 10 to be coated to the receiving unit and removing the coated substrate out of the receiving unit. In addition, the receiving unit 3 is used for receiving the substrate and located downstream of the conveying unit along a flowing direction F of the conveying gas flow. The coating system may further comprise a gas flow generating device 20 for generating the conveying gas flow. In this invention, the substrate may be a substrate for particulate filters, in particular a wall-flow filter. However, one skilled in the art should be understood that the substrate may also be other types of substrates that need to be coated.

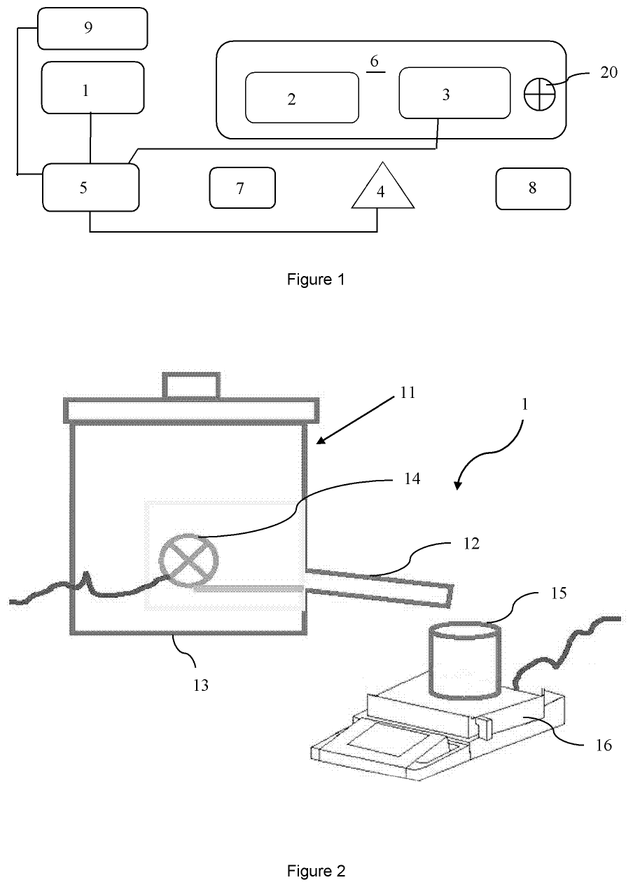

As shown in FIG. 2, in a preferred embodiment, the dosing unit 1 may comprise an automatic material dosing device 11, a material transfer container 15 and a weighing device 16. It can be seen from the figure that the automatic material dosing device 11 is configured to include a material container 13 with a dispensing port (or a dispensing tube) 12 and a dispensing mechanism 14 arranged in the material container. The solid materials to be conveyed are contained in the material container, and the dispensing mechanism 14 is used for dispensing the solid material into the material transfer container 15 such as a cup through the dispensing port 12, and the solid material in the material transfer container is weighed by the weighing device. In an example, the dispensing mechanism 14 may be, for example, a threaded screw mechanism for pushing solid materials into the dispensing pipe which is arranged obliquely.

In the above dosing unit 1, the dispensing mechanism 14 and the weighing device 16 are respectively in communication with the control unit 4, and the control unit 4 receives a weight measurement value W1 of the solid material dispensing into the material transfer container from the weighing device 16, and compares the weight measurement value W1 with the set weight W of the solid material to be conveyed, and the control unit 4 will control the dispensing mechanism 14 to stop dispensing the solid material, if the weight measurement value W1 is in the range of the set weight W±5%. In actual operation, the weight measurement value W1 of the solid material is the weight measurement value Wt of the weighing device 16 subtract the weight Wc of the material transfer container 15. Since it is difficult to avoid adhering some solid materials to the wall of the material transfer container 15, after feeding the solid materials in the material transfer container 15 into the conveying unit 2, it is necessary to put the empty material transfer container 15 on the weighing device 16 for re-weighing, and the measured value is Wr, then Wt−Wr is the actual material weight G feeding into the conveying unit 2. If the actual material weight G is within the specified range, for example, in the range of the set weight W±5%, the dosing unit 1 will continue to weigh the solid material for the next substrate, otherwise, the weighing device 16 will send a signal to the control unit to mark the substrate coated in this time as a “reject product”.

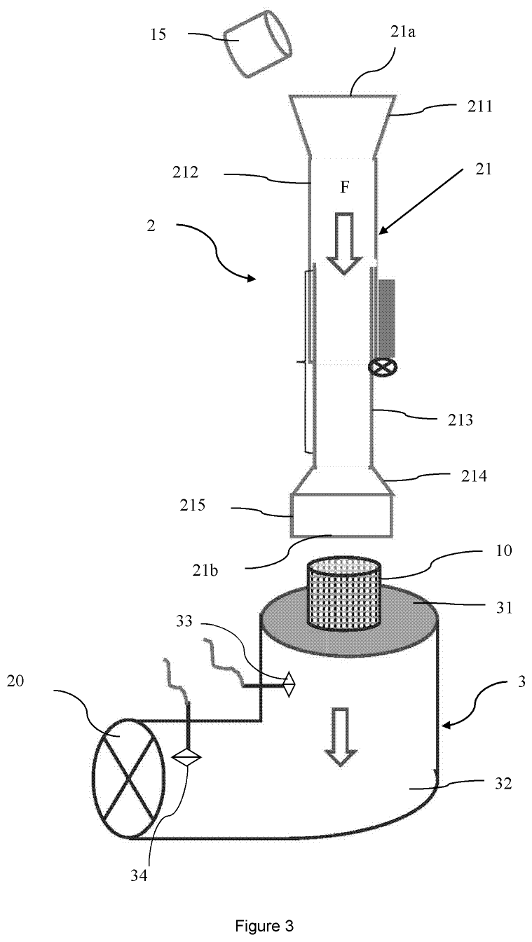

As shown in FIG. 3, in an embodiment according to the present invention, the conveying unit 2 comprises a conveying pipe 21 orientated vertically, the conveying pipe may comprise a first conical pipe section 211, a first cylindrical pipe section 212, a second cylindrical pipe section 213, a second conical pipe section 214 and a third cylindrical pipe section 215 which are sequentially connected. Advantageously, the second cylindrical pipe section 213 is movably connected to the first cylindrical pipe section 212 such that the second cylindrical pipe section 213 can move between a first position in which the third cylindrical pipe section 215 may drop down to be airtightly connected with the receiving unit 3 and cover the substrate 20 to be coated, and a second position in which the third cylindrical pipe section 215 may lift up to leave enough space for the automatic transfer mechanism 4 to operate the substrate to be coated or the coated substrate relative to the first cylindrical pipe section 212. The connecting means between the second cylindrical pipe section 213 and the first cylindrical pipe section 212 are known to those skilled in the art, and will not be repeated here.

In this embodiment, the first conical pipe section 211 is used for receiving the weighed solid material from the material transfer container 15 and is preferably convergent along the flow direction F of the conveying gas flow, so that the solid materials from the material transfer container 5 are fed into the conveying pipe more easily. It should be understood that the first conical pipe section 211 is optional or omissible. In addition, in the present application, the cylindrical pipe section here can also be replaced with a pipe section having a cross section of other shapes, such as a square cross section, which also fall within the scope of the present application. Moreover, in the present invention, the second conical pipe section 214 is configured to gradually expand along the flow direction F of the conveying airflow.

In the embodiment shown in FIG. 3, the length of the second cylindrical pipe section 213 may be less than the length of the first cylindrical pipe section 212. Moreover, for example, the (inner) diameter D of the first cylindrical pipe section 212 may be selected as 40 mm to 140 mm, preferably 60 mm to 100 mm, and more preferably 60 mm or 100 mm. The (inner) diameter of the second cylindrical pipe section 213 is smaller than that of the first cylindrical pipe section 212, for example, is 2 mm-5 mm smaller than that of the first cylindrical pipe section 212, so that the second cylindrical pipe section can move freely in the first cylindrical pipe section. The diameter and height of the third cylindrical pipe section 215 should be selected to be able to cover said substrate 10 to be coated. For example, the height of the third cylindrical pipe section 215 may be 1.2 to 1.8D, for example 1.5D. In particular, the height of the third cylindrical pipe section may be in the range of 60 mm to 200 mm, preferably 90 mm to 150 mm, such as 90 mm or 150 mm. In addition, the diameter of the third cylindrical pipe section 215 may be in the range of 2.5D to 3D. Specifically, the diameter of the third cylindrical pipe section 215 may be in the range of 100 mm to 400 mm, preferably 150 mm to 300 mm, such as 150 mm or 300 mm. In this case, the diameter of the third cylindrical pipe section is larger than that of the diameter of the circular cross-section of the substrate or the minor axis of the elliptical cross-section of the substrate in case the substrate is an elliptic cylinder.

In addition, during the operation of the coating system, the diameters of the first cylindrical pipe section 212 and the second cylindrical pipe section 213, and the heights of the second conical pipe section 214 and the third cylindrical pipe section 215 are very important for the distribution of solid materials coated on the substrate. Especially for the height of the second conical pipe section 214, the larger its height value is, the turbulence will be generated in the cavity defined by the first cylindrical pipe section 214, and the distribution of solid materials will be better. For example, the height of the second conical tube section may be in the range of 20 mm to 200 mm, preferably 100 mm to 200 mm. According to an embodiment of the present invention, further referring to FIG. 3, the receiving unit 3 may comprise a holding mechanism 31 for fixedly holding the substrate 10 to be coated, and the holding mechanism may be airtightly connected to the gas flow generating device 20 by means of a connecting pipeline 32, the cross section of which is larger than that of the substrate 10. For example, the gas flow generating device 20 may be a fan arranged downstream of the receiving unit 3 to generate the conveying gas flow flowing from an inlet end 21a of the conveying pipe to an outlet end 21b thereof. Advantageously, the holding mechanism 31 is an inflatable flexible holder which can be adjusted to accommodate substrates 10 of different sizes. For example, the inflatable flexible holder may be in the form of a swimming ring or a tire.

To prevent the fan from overheating, a cooler (not shown) may be provided in the connecting pipeline 32 near the fan. Moreover, in order to maintain the stability of the conveying air flow, a gas buffer box (not shown) may be connected to the connecting pipeline. In addition, a pressure sensor 33 and a flow rate sensor 34 are provided in the connecting pipeline, the control unit 5 is in communication with the pressure sensor 33 and the flow rate sensor 34 to receive a gas flow rate and a pressure measured in the connecting pipeline through the pressure sensor and the flow rate sensor, so as to monitor the pressure and gas flow rate in the connecting pipeline 32 in real time to control the back pressure stability of the substrate.

In addition, a branch pipe (not shown) which can fluidly communicate the connecting pipeline 32 with the external environment may be further arranged near the cooler, and a control valve is arranged in the branch pipe, and the control valve may be fully or partially opened when the coating system works, so as to control the flow rate of the conveying air flow in the conveying unit 2.

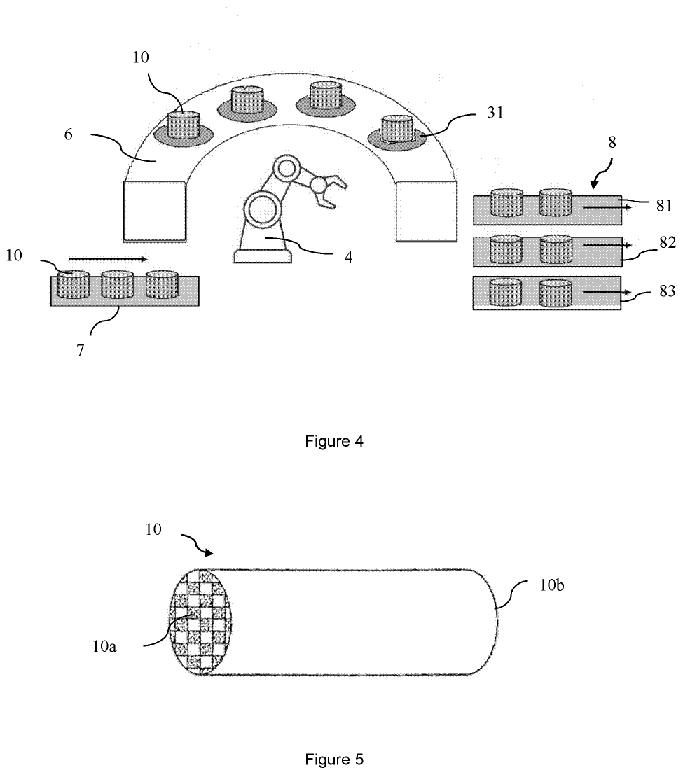

As shown in FIG. 4, according to an embodiment of the present invention, the coating system comprises a loading table 6 which is a semicircle table, the automatic transfer mechanism 4 is arranged at the center of the semicircle arc so that the distance from the automatic transfer mechanism to each receiving unit is the same. The coating system further comprises a feeding device 7 arranged on one side of the automatic transfer mechanism 4 close to the loading table 6, and an output device 8 arranged on the other side of the automatic transfer mechanism 4 close to the loading table 6.

One skilled in the art should understand that the loading table in the present invention may also be configured in other suitable shapes, for example, other arc shapes different from semicircles, which are also fall within the scope of the present application. In this embodiment, four combinations consisting of the conveying unit 2 and the receiving unit 3 may be arranged on the loading table. For the sake of simplicity, only the containing unit 3 in the combination is shown in FIG. 4. Herein, the automatic transfer mechanism 4 is a robot which is in communication with the control unit 5, and the control unit controls the robot to determine which receiving unit is in an idle state, and then transfer the substrate to be coated to the receiving unit which is idle.

In an embodiment according to the present invention, the output device 8 may comprise at least two output conveyors, one of the output conveyors may be used for qualified products and the other one of the output conveyors may be used for unqualified products.

In the embodiment shown in FIG. 4, for example, the output conveyor 8 may include three output conveyors 81, 82, 83, one 81 of which is used for unqualified products, and the other two output conveyors 82, 83 is used for qualified products which are in different back pressure ranges.

Preferably, the coating system may further comprise a backpressure measuring device 9, which is able to measure the backpressure of the substrate to be coated, such that the weight of the solid material to be coated on the substrate can be determined based on the measured backpressure value.

In the present invention, referring to FIG. 5, the substrate 10 is, for example, a wall-flow filtered substrate, and has an inlet side 10a and an outlet side 10b, wherein the substrate 10 is arranged in the inflatable flexible holder with its inlet side 10a facing the conveying unit 2, in other words, with its inlet side 10a facing the connecting pipeline 22. When the cylindrical pipe section 213 is in the first position, the third cylindrical pipe section 215 may drop down to be airtightly connected to the inflatable flexible holder. The substrate shown in FIG. 5 has a circular cross section, and the diameter of the cross-section of the substrate with relatively small size may be in the range of 95 mm˜155 mm, while the diameter of the cross-section of the substrate with relatively large size may be in the range of 160 mm˜350 mm, for example. In an embodiment not shown, the cross-section of the substrate may be elliptical, in which case, the minor axis of the elliptical cross-section of the substrate with relatively small size may be in the range of 95 mm˜155 mm, while the minor axis of the cross-section of the substrate with relatively large size may be in the range of 160 mm˜350 mm, for example.

The present invention also relates to a process of coating a substrate 10 with the above-mentioned coating system to obtain a product such a wall-flow filter, the process comprises the steps of: providing the substrate 10; transferring the substrate to a receiving unit 3 by an automatic transfer mechanism 4, and fixedly holding the substrate in the receiving unit; pre-weighing a solid material to be coated on the substrate by a dosing unit 1; mixing the weighed solid material with the conveying gas flow and convey them to the receiving unit 3 by the conveying unit to coat the substrate; and removing the coated substrate from the receiving unit 3 by the automatic transfer mechanism 4.

In the step of providing the substrate 10, a scanning device (not shown in the figure) can be provided to scan the provided substrate to judge whether the batch of the substrate is correct. If it is correct, the substrate will be fixed and held in the receiving unit 3, otherwise, the substrate will be judged as a reject substrate.

In the step of pre-weighing a solid material to be coated on the substrate by a dosing unit 1, the weight G of the solid materials, which are actually fed into the conveying unit 2, can also be measured by the weighing device 16 and sent to the control unit for comparing with the set weight W. In particular, the total weight of the material transfer container 15 and the solid material to be conveyed therein measured by the weighing device 16 is defined as Wt, after feeding the solid materials in the material transfer container 15 into the conveying unit 2, the material transfer container 15 is re-weighed by the weighing device 16 and the measured value is Wr, then Wt−Wr is the actual material weight G feeding into the conveying unit 2; if the actual material weight G is in the range of the set weight W±5%, the dosing unit 1 will continue to weigh the solid material for the next substrate, otherwise, the weighing device 16 will send a signal to the control unit to mark the substrate coated in this time as a “reject product”.

In the step of mixing the weighed solid material with the conveying gas flow and convey them to the receiving unit 3 to coat the substrate by the conveying unit 2, the flow rate of the conveying gas flow can be controlled. In order to make the obtained products with the qualified product characteristics and appearance, the conveying gas flow with different flow rates can be provided for substrates with different sizes. In addition, during coating, it is necessary to use a conveying gas flow with a suitable flow rate to purge the substrate to be coated for a certain period of time, such as 20 seconds. If the flow rate is not suitable and the purging time is not enough, the obtained product will be unqualified.

After the step of removing the coated substrate from the receiving unit 3, it is possible to judge whether the obtained product is qualified by a backpressure test. For example, if the backpressure of the desired product is P and the measured backpressure Pt=P (1±5%) the product can be judged as a qualified product, otherwise it can be judged as a unqualified product (reject product).

Preferably, the above method also comprises the step of measuring the backpressure of the substrate to be coated by a backpressure measuring device before the pre-weighing step, and determining the weight of the solid material to be coated on the substrate based on the backpressure measurement value.

Various modifications and variations conceivable by those skilled in the art can be made to the embodiments disclosed above without departing from the scope or spirit of the present disclosure. According to the disclosure, other embodiments will be obvious to those skilled in the art. This description and its disclosed examples are to be considered illustrative only, and the protection scope of the present disclosure is to be specified by the appended claims and their equivalents.

1. A coating system for coating a substrate, comprising:
a dosing unit for pre-weighing a solid material to be conveyed;
a conveying unit, for conveying the weighed solid material to the substrate to be coated by a conveying gas flow;
a receiving unit for receiving the substrate and located downstream of the conveying unit along a flowing direction of the conveying gas flow;
an automatic transfer mechanism for transferring the substrate to the receiving unit and removing the coated substrate out of the receiving unit;
a control unit for controlling the operation of the dosing unit, the receiving unit and the automatic transfer mechanism; and,
a gas flow generating device for generating the conveying gas flow.

2. The coating system according to claim 1, wherein the dosing unit comprises:
an automatic material dosing device comprising a material container with a dispensing port and a dispensing mechanism arranged in the material container;
a material transfer container; and,
a weighing device;
wherein the dispensing mechanism is used for dispensing the solid material into the material transfer container through the dispensing port, and the weighing device is used for weighing the solid material in the material transfer container.

3. The coating system according to claim 2, wherein,
the dispensing mechanism and the weighing device M are respectively in communication with the control unit, and the control unit, receives a weight measurement value of the solid material dispensing into the material transfer container from the weighing device and compares the weight measurement value with the set weight of the solid material to be conveyed, and the control unit will control the dispensing mechanism to stop dispensing the solid material, if the weight measurement value is in the range of the set weight±5%.

4. The coating system according to claim 1, wherein,
the conveying unit comprises a conveying pipe comprising a first cylindrical pipe section, a second cylindrical pipe section, a second conical pipe section and a third cylindrical pipe section which are sequentially connected;
wherein the second cylindrical pipe section is movably connected to the first cylindrical pipe section such that the second cylindrical pipe section can move between a first position in which the third cylindrical pipe section may drop down to be airtightly connected with the receiving unit and cover the substrate, and a second position in which the third cylindrical pipe section may lift up to leave enough space for the automatic transfer mechanism to operate the substrate to be coated or the coated substrate relative to the first cylindrical pipe section.

5. The coating system according to claim 4, wherein,
the conveying pipe is orientated vertically and further comprises a first conical pipe section connected to the first cylindrical pipe section, which is used for receiving the weighed solid material;
wherein the first conical pipe section is convergent along the flow direction of the conveying gas flow, and the second conical pipe section is divergent along the flow direction of the conveying gas flow.

6. The coating system according to claim 5, wherein,
the second cylindrical pipe section has a length which is smaller than that of the first cylindrical pipe section;
the second cylindrical pipe section has a diameter which is smaller than that of the first cylindrical pipe section; and,
the third cylindrical pipe section has a diameter and a height, which are selected such that the third cylindrical pipe section can cover the substrate to be coated.

7. The coating system according to claim 4, wherein,
the inner diameter of the first cylindrical pipe section is defined as D;
the second cylindrical pipe section has an inner diameter which is 2 mm to 5 mm smaller than that of the first cylindrical pipe section;
the second conical pipe section has a height which is in the range of 0.5D to 1.5D;
the third cylindrical pipe section has a height which is in the range of 1.2D to 1.8D; and,
the diameter of the third cylindrical pipe section is in the range of 2.5D to 3D;
wherein the diameter of the third cylindrical pipe section is larger than that of the diameter of the circular cross-section of the substrate or the minor axis of the elliptical cross-section of the substrate in case the substrate is an elliptic cylinder.

8. The coating system according to claim 4, wherein,
the first cylindrical pipe section has an inner diameter in the range of 40 mm to 140 mm;
the second cylindrical pipe section has an inner diameter which is 2 mm to 5 mm smaller than that of the first cylindrical pipe section;
the second conical pipe section has a height in the range of 20 mm to 200 mm;
the third cylindrical pipe section has a height in the range of 60 mm to 200 mm; and,
the diameter of the third cylindrical pipe section is in the range of 100 mm to 400 mm.

9. The coating system according to claim 1, wherein the receiving unit comprises:
a holding mechanism a for fixedly holding the substrate; and,
a connecting pipeline for airtightly connecting the holding mechanism and the substrate to the gas flow generating device;
wherein a pressure sensor and a flow rate sensor are arranged in the connecting pipeline
wherein the gas flow generating device is a fan arranged downstream of the receiving unit to generate the conveying gas flow flowing from an inlet end of the conveying pipe to an outlet end thereof; and a cooler is also arranged in the connecting pipeline near the fan.

10. (canceled)

11. The coating system according to claim 9, wherein the holding mechanism is an inflatable flexible holder which can be adjusted to hold the substrates of different sizes; and the control unit is in communication with the pressure sensor and the flow rate sensor to receive a gas flow rate and a pressure measured in the connecting pipeline through the pressure sensor and the flow rate sensor;
wherein the connecting pipeline has a cross section which is larger than that of the substrate.

12. The coating system according to claim 11, wherein the substrate is a substrate for a wall-flow filter and has an inlet side and an outlet side, and the substrate is arranged in the inflatable flexible holder with its inlet side as facing the conveying unity; and,
wherein in the first position, the third cylindrical pipe section may drop down to be airtightly connected to the inflatable flexible holder.

13. The coating system according to claim 1, further comprising:
a loading table on which at least two combinations consisting of the conveying unit and the receiving unit are arranged;
a feeding device arranged on one side of the automatic transfer mechanism close to the loading table; and,
an output device arranged on the other side of the automatic transfer mechanism-j close to the loading table.

14. The coating system according to claim 13, wherein the loading table is a circular arc table, and the at least two combinations are installed on the loading table along the circumferential direction of the circular arc;
wherein the automatic transfer mechanism is arranged at the center of the circular arc so that the distance from the automatic transfer mechanism to each receiving unit is the same.

15. The coating system according to claim 14, wherein the loading table is a semi-circular table, and four combinations consisting of the conveying unit and the receiving unit are arranged on the loading table, wherein the automatic transfer mechanism is a robot which is in communication with the control unit, and the control unit controls the robot to determine which receiving unit is in an idle state, and then transfer the substrate to be coated to the receiving unit which is idle.

16. The coating system according to claim 13, wherein the output device comprises at least two output conveyors, one of the output conveyors is used for qualified products and the other of the output conveyors is used for unqualified products.

17. The coating system according to claim 1, further comprising a backpressure measuring device which may be used for measuring the backpressure of the substrate to be coated, such that the weight of the solid material to be coated on the substrate can be determined based on the measured backpressure value.

18. A method of coating a substrate with the coating system according to claim 1, comprising:
providing the substrate;
transferring the substrate to a receiving unit) by an automatic transfer mechanism, and fixedly holding the substrate in the receiving unit;
pre-weighing a solid material to be coated on the substrate by a dosing unit;
mixing the weighed solid material with the conveying gas flow and convey them to the receiving unit by the conveying unit to coat the substrate; and,
removing the coated substrate from the receiving unit by the automatic transfer mechanism.

19. The method according to claim 18, wherein in the step of pre-weighing a solid material to be coated on the substrate by a dosing unit, the total weight of the material transfer container and the solid material to be conveyed therein measured by the weighing device is defined as Wt, after feeding the solid materials in the material transfer container into the conveying unit, the material transfer container is re-weighed by the weighing device and the measured value is Wr, then Wt−Wr is the actual material weight G feeding into the conveying unit 2; if the actual material weight G is in the range of the set weight W±5%, the dosing unit will continue to weigh the solid material for the next substrate, otherwise, the weighing device 16 will send a signal to the control unit to mark the substrate coated in this time as a “reject product”.

20. The method according to claim 18, wherein after the step of removing the coated substrate from the receiving unit 3, it is possible to judge whether the obtained product is qualified by a backpressure test. For example, if the backpressure of the desired product is P and the measured backpressure Pt=P (1±5%), the product can be judged as a qualified product, otherwise it can be judged as a unqualified product (reject product).

21. The method according to claim 18, further comprising measuring the backpressure of the substrate to be coated by a backpressure measuring device before the pre-weighing step, and determining the weight of the solid material to be coated on the substrate based on the backpressure measurement value.
